(19) United States
(12) Patent Application Publication
(10) Pub. No.: US 2007/0050703 A1
(43) Pub. Date: Mar. 1, 2007

(54) Methods, systems and computer program products for analyzing a hypertext markup language (HTML) document

(76) Inventor: Pierre Lebel, Cary, NC (US)

Correspondence Address: MYERS BIGEL SIBLEY & SAJOVEC, PO BOX 37428, RALEIGH, NC, 27627, US

(21) Appl. No.: 11/212,790

(22) Filed: Aug. 26, 2005

(51) Int. Cl. G06F 17/00

(52) U.S. Cl. 715/513

(57) ABSTRACT

Methods, systems and computer program products for generating a hierarchical representation of a hypertext markup language (HTML) document. A state of a web page is captures at a point in time. A plurality of content elements of the captured web page are identified. The content elements are organized to provide a grouping of the content elements based on an associated type and/or content of respective ones of the content elements to provide the hierarchical representation of the HTML document.

### FIELD OF THE INVENTION

The present invention relates generally to administration of web pages, and more particularly, to administration of hypertext markup language (HTML) web pages.

### BACKGROUND OF THE INVENTION

As the popularity of the world wide web continues to increase, so does the demand for quality of service, for example, fast connection and refresh rates. Thus, service providers may continue to look for ways to monitor performance of the service and debug the system for any problems that may arise. Typically, web pages are created using the hypertext markup language (HTML). HTML may be used to create hypertext documents on the World Wide Web and control how the web pages appear on a user display. HTML web pages are dynamically generated based on a multitude of variables and, therefore, are typically very difficult to debug. Accordingly, provision of a standard quality of service may be hindered by the inability to identify and correct any bugs that may be present in the HTML code.

### SUMMARY OF THE INVENTION

Embodiments of the present invention provide methods, systems and computer program products for generating a hierarchical representation of a hypertext markup language (HTML) document. A state of a web page is captured at a point in time. A plurality of content elements of the captured web page are identified. The content elements are organized to provide a grouping of the content elements based on an associated type and/or content of respective ones of the content elements to provide the hierarchical representation of the HTML document.

In some embodiments of the present invention, the content elements may be organized to provide a subset of the content elements based on the type and/or the content of the content elements in the hierarchical representation of the HTML document. The subset may include only frame and/or form type content elements in the hierarchical representation of the HTML document.

In further embodiments of the present invention, a change in the web page may be detected. Capturing a state, identifying a plurality of content elements and organizing the content elements may be repeated responsive to detection of the change in the web page to provide an updated hierarchical representation of the HTML document.

In some embodiments of the present invention, a plurality of content elements associated with a child window nested in the captured web page may be identified. The content elements associated with the child window may be grouped in the hierarchical representation of the HTML document. The grouping of the plurality of content elements associated with the child window may be nested in groupings of a parent window of the hierarchical representation of the HTML document.

In further embodiments of the present invention, the content elements may be organized to include an identification of attributes and of properties associated with ones of the content elements in the hierarchical representation of the HTML document. The attributes and/or properties associated with ones of the content elements may be grouped separately in the hierarchical representation of the HTML document.

In still further embodiments of the present invention, the content elements may be organized to include an identification of parent/child relationships and screen coordinates associated with ones of the content elements in the hierarchical representation of the HTML document. The screen coordinates may be view coordinates in a browser window.

In some embodiments of the present invention, the hierarchical representation of the HTML document may be displayed proximate a display of the web page on a user display. A user designation of one of the content elements in the displayed hierarchical representation of the HTML document may be received. A region of the displayed web page associated with the designated one of the content elements may be highlighted responsive to the received user designation of the one of the content elements. The view of the web page in a browser window may be automatically modified so the highlighted region is visible.

In still further embodiments of the present invention, the hierarchical representation of the HTML document may be displayed proximate a display of the web page on a user display. A user designation of a region of the displayed web page may be received. One of the content elements in the displayed hierarchical representation of the HTML document associated with the designated region of the displayed web page may be highlighted responsive to the received user designation of the region. The view of the hierarchical representation of the HTML document may be automatically modified in a display window so that the highlighted content element is visible.

### BRIEF DESCRIPTION OF THE DRAWINGS

FIG. 1 is a block diagram illustrating data processing systems according to some embodiments of the present invention.

FIGS. 2 through 5B are a screen shots illustrating various aspects according to some embodiments of the present invention.

FIG. 6A illustrates a block of HTML code to be converted to a hierarchical representation according to some embodiments of the present invention.

FIG. 6B is a screen shot illustrating a hierarchical representation of the HTML code illustrated in FIG. 6A according to some embodiments of the present invention.

FIGS. 7 and 8 are flowcharts illustrating operations for generating a hierarchical representation of a hypertext markup language (HTML) document according to some embodiments of the present invention.

FIGS. 9 and 10 are flowcharts illustrating operations for displaying and manipulating the hierarchical representation of an HTML document according to some embodiments of the present invention.

### DETAILED DESCRIPTION OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that although the terms first and second are used herein to describe various elements these elements should not be limited by these terms. These terms are only used to distinguish one element from another element. Thus, a first element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The invention is described in part below with reference to flowchart illustrations and/or block diagrams of methods, systems and computer program products according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

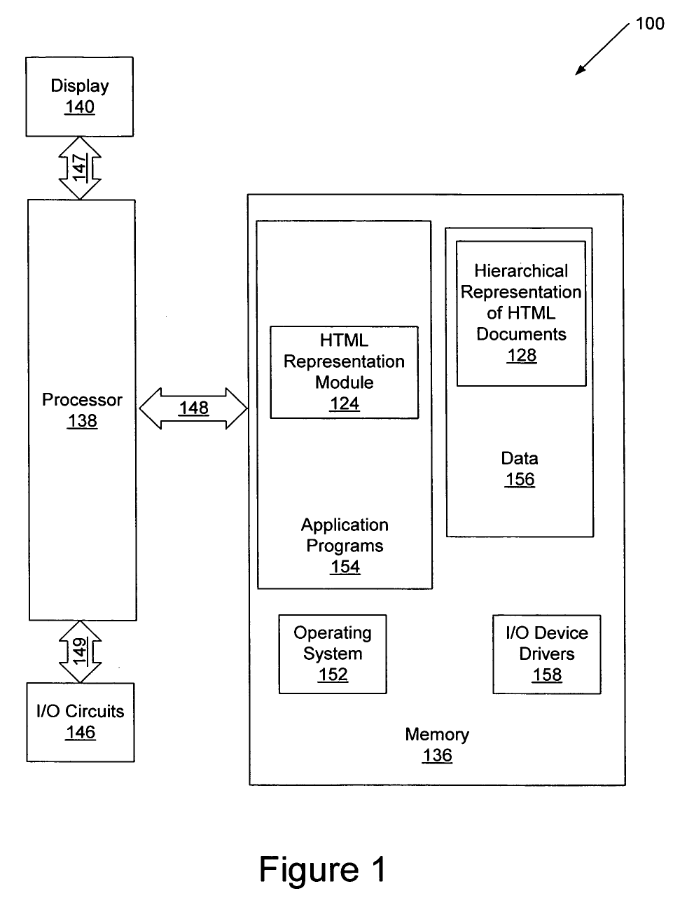

Embodiments of the present invention will now be discussed with respect to FIGS. 1 through 10. As discussed herein, some embodiments of the present invention provided methods, systems and computer program products for generating a hierarchical representation of a hypertext markup language (HTML) document. For example, a state of a web page may be captured at a particular point in time. A plurality of HTML content elements may be identified for the captured web page. As will be discussed further herein, HTML content elements are the basic components of an HTML document. Content elements generally have both a type and a content.

An element type, may include, for example, FRAME, FORM, HEADINGS, PARAGRAPHS, LISTS, FONTS, TABLES, and the like. It will be understood that HTML has many defined types of elements and a user may also create new types of elements, thus, embodiments of the present invention are not limited to the examples provided herein.

The content of a content element may be, an attribute, a property and/or a child. A content element attribute may provide a selection criterion defining the manner in which the content elements are to be displayed. If no attribute is specified for a content element, the attribute content may be omitted. A content element property may specify a unique identification (ID) for the content element and map coordinates associated with the content element relative to the particular view on a user's display. Finally, a child of a content element is a content element nested within another (or parent) content element in the HTML code or a content element contained within another content element.

Once the plurality of content elements are identified for the captured web page, the content elements may be organized to provide a grouping of the content elements based on the associated type and/or content of the respective content elements to provide the hierarchical representation of the HTML document. For example, according to some embodiments of the present invention, a hierarchical tree of the content elements in the captured web page is generated. The hierarchical tree may include nodes, which correspond to the content elements of the captured elements. Each element (node) of the tree can be expanded to provide the associated attributes, properties and/or child (children) for that node (content element). The hierarchical tree may also be referred to herein as representing the architecture of the captured page. The hierarchical representation of the captured web page (HTML document) provided according to some embodiments of the present invention may facilitate debugging of dynamically generated HTML web pages, as the hierarchical relationships between the content elements and the associated attribute, properties and/or child(ren) may be displayed to the user as will be discussed further below with respect to FIGS. 1 through 10.

Referring now to FIG. 1, an exemplary data processing system 100 that may be included in devices operating in accordance with some embodiments of the present invention will be discussed. As illustrated, the data processing system 100 includes a display 140, a processor 138, a memory 136 and input/output circuits 146. The data processing system 100 may be incorporated in, for example, a personal computer, server, router or the like. The processor 138 communicates with the memory 136 via an address/data bus 148, communicates with the input/output circuits 146 via an address/data bus 149 and communicates with the display via an address/data bus 147. The input/output circuits 146 can be used to transfer information between the memory 136 and another computer system or a network using, for example, an Internet Protocol (IP) connection. These components may be conventional components, such as those used in many conventional data processing systems, which may be configured to operate as described herein.

In particular, the processor 138 can be any commercially available or custom microprocessor, microcontroller, digital signal processor or the like. The memory 136 may include any memory devices containing the software and data used to implement the functionality circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 may be a content addressable memory (CAM).

As further illustrated in FIG. 1, the memory 136 may include several categories of software and data used in the data processing system 100: an operating system 152; application programs 154; input/output device drivers 158; and data 156. As will be appreciated by those of skill in the art, the operating system 152 may be any operating system suitable for use with a data processing system, such as OS/2, AIX or zOS from International Business Machines Corporation, Armonk, N.Y., Windows95, Windows98, Windows2000 or WindowsXP from Microsoft Corporation, Redmond, Wash., Unix or Linux. The input/output device drivers 158 typically include software routines accessed through the operating system 152 by the application programs 154 to communicate with devices such as the input/output circuits 146 and certain memory 136 components. The application programs 154 are illustrative of the programs that implement the various features of the circuits and modules according to some embodiments of the present invention. Finally, the data 156 represents the static and dynamic data used by the application programs 154, the operating system 152, the input/output device drivers 158, and other software programs that may reside in the memory 136. As illustrated in FIG. 1, the data 156 may include stored hierarchical representation(s) of HTML documents and captured web pages for use by the circuits and modules of the application programs 154 according to some embodiments of the present invention as discussed further herein.

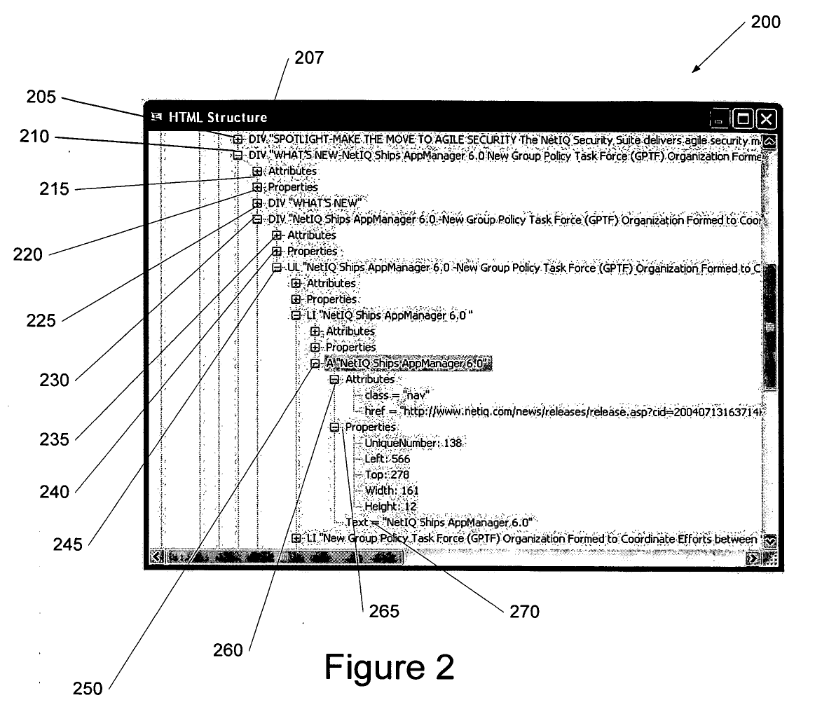

As further illustrated in FIG. 1, the application programs 154 include an HTML representation module 124 according to some embodiments of the present invention. As discussed above, the HTML representation module 124 may be configured to capture a state of a web page on a user display 140 at a particular point in time, identify a plurality of HTML content elements for the captured web page and organize the content elements to provide the hierarchical representation of the HTML document according to some embodiments of the present invention. An exemplary hierarchical representation 200 of an HTML document according to some embodiments of the present invention is illustrated in FIG. 2. As illustrated in FIG. 2, the hierarchical representation 200 of the captured web page includes first and second content elements 205 and 210. As discussed above, content elements generally have both a type and a content associated therewith. As illustrated, both the first and second content elements 205 and 210 have an associated type “DIV” 207. In HTML, the DIV type offers a generic mechanism for adding structure to documents. The DIV type defines content at a block-level, but does not typically impose any other presentational idioms on the content. Thus, the DIV type in conjunction with other attribute types, may be used to tailor the HTML web page documents to user preferences. As discussed above, there are many types of elements provided by the HTML standard, for example, FRAME, FORM, HEADINGS, PARAGRAPHS, LISTS, FONTS, TABLES, and other types may be created, thus, embodiments of the present invention are not limited to the types provided herein for exemplary purposes.

As further illustrated in FIG. 2, the second content element 210 has been expanded to show lower levels of the hierarchy (architecture), thereby illustrating the associated attributes 215, properties 220 and first and second children 225 and 230, i.e., the content portion of the content element. The second child 230 has been further expanded to illustrate the associated attributes 235, properties 240 and child 245 thereof, and so on. As discussed above, attributes may provide a selection criterion defining the manner in which the content elements are to be grouped in the hierarchy and displayed on a user display, for example, display 140(FIG. 1). If no attribute is specified for a content element, the attribute content may be omitted.

As illustrated in FIG. 2, the attributes 260 of content element 250 include: class=“nav” and href=“http://www.netiq.com/news . . . ” The class attribute assigns one or more class names to a content element and, thus, the content element may be said to belong to these classes. A class name may be shared by several content element instances. The “href” attrbute indicates a universal resource locator (URL). For example, the href attribute in FIG. 2 creates a link to the web page specified therein.

As further illustrated in FIG. 2, the properties 265 of content element 250 include a unique identification (Unique number: 138) and map coordinates (left, top, width, height) associated with the content element relative to the particular portion of the web page that is visible on a user's display (display 140 of FIG. 1), for example, the browser view. The coordinates may indicate a view of what the user sees on the user display, where a negative number, for example, would indicate a position above the viewed portion of the page. In other words, a first hierarchical representation of a web page may be generated based on a current view of the web page. If the user then scrolls down the web page, a second hierarchical representation of the web page may be generated based on the scrolled view of the web page, where element map coordinates may change while the hierarchy may otherwise remain unchanged. The property coordinates associated with a same content element may be different based on the user's view of the web pages, i.e., original view and scrolled view. A text string 270 may also be associated with the content element 260 as illustrated in FIG. 2.

According to some embodiments of the present invention, a hierarchical representation 200 of a static view of a web page as seen by a user or web browser may be generated. Thus, when a user or web browser encounters a problem, a technical support person may use the hierarchical representation 200 (a snap shot of the web page structure) to debug the web page.

Referring again to FIG. 1, as discussed with respect to FIG. 2, as the view, i.e., what the user sees on the display, changes, so does the hierarchical representation of the web page. Other user actions may also dynamically change the web page, such as a “click” on a portion thereof. Accordingly, the HTML representation module 124 may be further configured to automatically capture the new state of the web page, identify a plurality of content elements and provide the hierarchical representation of the web page responsive to a detected change in the web page, for example, when a user scrolls down. In some embodiments of the present invention, the HTML representation module 124 may be configured to generate an updated hierarchical representation of the web page responsive to a user command, i.e., the update does not have to be done automatically.

While the present invention is illustrated with reference to the HTML representation module 124 being an application program in FIG. 1, as will be appreciated by those of skill in the art, other configurations fall within the scope of the present invention. For example, rather than being an application program 154, the HTML representation module may also be incorporated into the operating system 152 or other such logical division of the data processing system 100, such as dynamic linked library code. Furthermore, while the HTML representation module is illustrated in a single data processing system, as will be appreciated by those of skill in the art, such functionality may be distributed across one or more data processing systems. Thus, the present invention should not be construed as limited to the configuration illustrated in FIG. 1, but may be provided by other arrangements and/or divisions of functions between data processing systems. For example, although FIG. 1 is illustrated as having a single HTML representation module 124, more modules may be added without departing from the scope of the present invention.

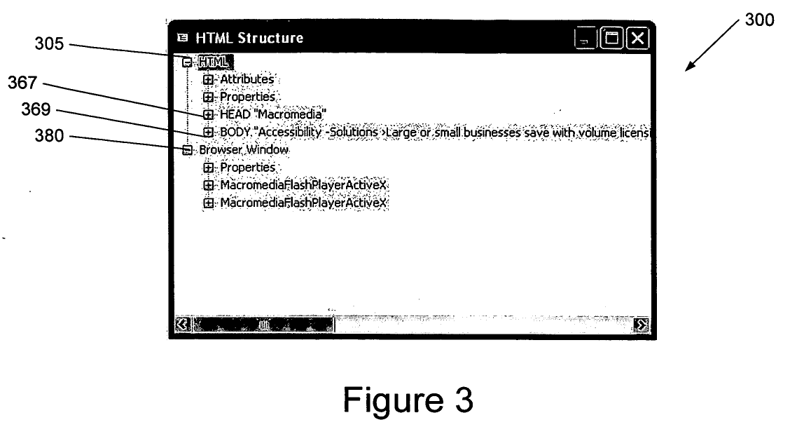

The hierarchical representation of the web page may have two main sections or parts. For example, as illustrated in FIG. 3 the hierarchical representation 300 of the web page may include an HTML section 305 and a browser window section 380. The HTML section 305 includes, as discussed with respect to FIG. 2, the content elements and associated types and contents (attributes, properties and children). The browser window section 380, according to some embodiments of the present invention, may display a hierarchy of other windows, if any, nested inside the browser window. For example, an HTML page may include a window, the position of which is included in the HTML code, but the content of which may be ActiveX controls. ActiveX controls may require a dedicated window resource. Thus, for example, the browser window has a dedicated window, but the browser window may themselves be objects of embedded HTML elements, which will be included in the HTML section 305. Thus, the HTML section 305 and the browser window section 380 may be at the same level of the hierarchy represented in the hierarchical representation 300 of a web page.

As further illustrated in FIG. 3, some embodiments of the present invention provide a base view. A BASE is a reference URL provided to resolve all relative REF and SRC paths on the page. The BASE, when present, is located in the HEAD (Header). For example, the base is included in the header in the following code:

```
<head>
        <title>Peppers</title>
        <base href=“http://www.somedomain.com/directory/” />
<head>
```

If a BASE exists, the hierarchical representation may completely duplicate the BODY in the BASE. As it may be confusing and expensive to display the BODY twice, only one of the BODY elements may be displayed. For example, the BODY of the HTML page may be duplicated under the BASE structure in the hierarchical representation (tree) according to some embodiments of the present invention. In these embodiments of the present invention, the BODY may be empty and all relative paths may be resolved in the BASE. Thus, according to some embodiments of the present invention, a user may right-click on the hierarchical representation 300 to move the BODY from the normal location following the HEAD to the BASE. The pull down menu that appears when the user right-click's may indicate “Display Body from Base.”

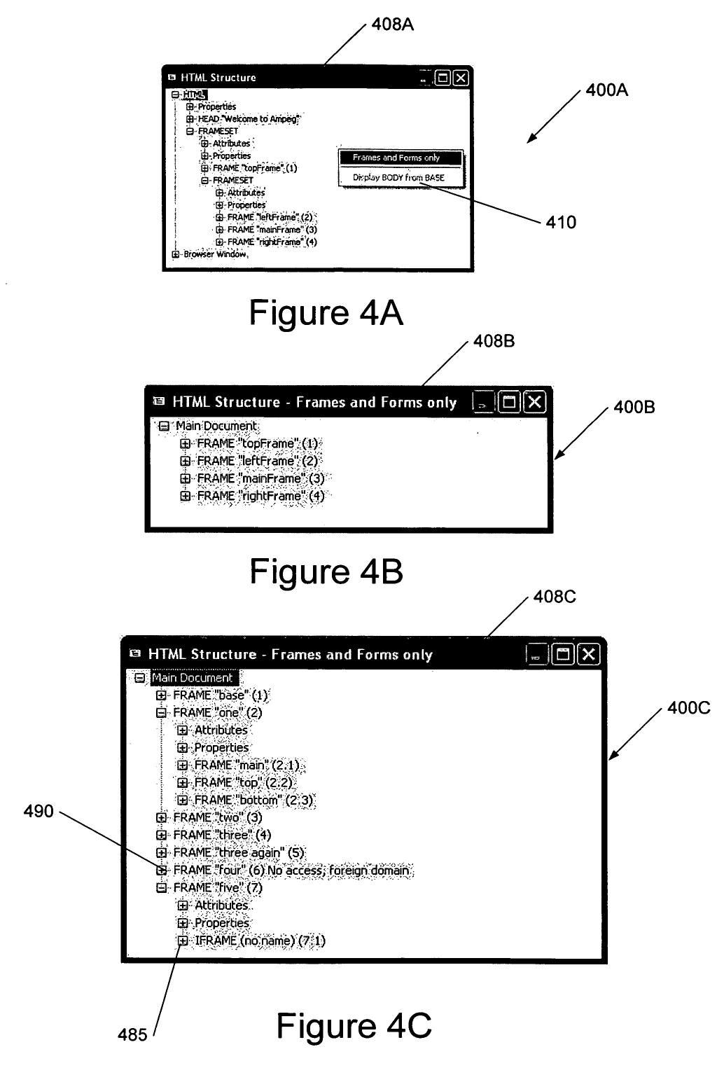

In some embodiments of the present invention, the hierarchical representation of the web page may only include a subset of content elements. For example, a user may designate a subset of content elements to be included in the hierarchical representation, such as a subset including only content elements having a certain type and/or content. FIG. 4A illustrates a hierarchical representation 400A of a web page according to some embodiments of the present invention, which includes all of the content elements associated with the captured web page as discussed above. As illustrated therein, it may be possible to right-click anywhere on the hierarchical representation (tree view) 400C to obtain a menu 410 which allows the user to select content elements having types=“Frames and Forms only.” If there is a content element having a Frame or Form type, these content elements will be visible on the hierarchical representation. For example, as illustrated in FIG. 4B, a hierarchical representation 400B including only content elements having a Frame type is provided. Thus, only Frame types, and no Form types, may have been available. The Frames illustrated in FIG. 4B all have names, for example, “topframe”(1), “leftframe”(2) and so on. Furthermore, as illustrated in FIGS. 4A through 4C, the window captions 408A through 408C may indicate the contents of the hierarchical representation, for example, “Frames and Forms only” (408B and 408C).

As further illustrated in FIG. 4C, Frame types do not necessarily have names, for example, IFRAME 485. Furthermore, Frame types may be nested. The hierarchical representation 400C also includes a Frame that is indicated as having a foreign domain, “FRAME ‘four’ (6) No access, foreign domain” 490. Thus, the SRC attribute, which indicates the URL of the document that should go in the frame, points to a domain that is foreign to the main page domain. The content of that FRAME 490 may, therefore, not be shown in the hierarchical representation 400C.

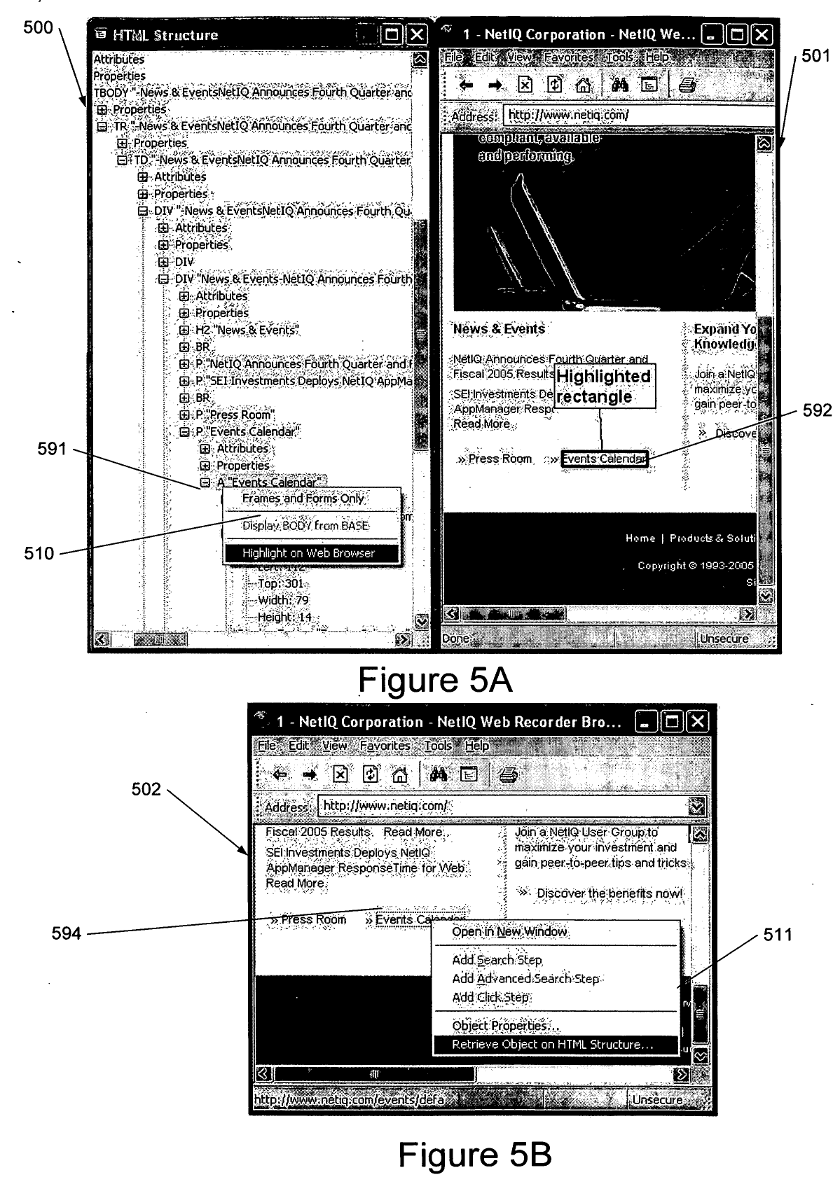

Referring now to FIGS. 5A and 5B, screen shots illustrating further operations and functionalities according to some embodiments of the present invention will be discussed. In some embodiments of the present invention, it may be possible to retrieve an object on the hierarchical representation of the web page by selecting/designating the corresponding region on the web page, which will cause the associated content element to be highlighted on the hierarchical representation. Similarly, a content element may be designated on hierarchical representation and the corresponding region may be highlighted on the web page.

A hierarchical representation 500 of a web page and the captured web page 501 are illustrated side by side on a user display as illustrated in FIG. 5A. As further illustrated therein, a user may designate one of the content elements 591 in the displayed hierarchical representation 500 of the web page. As illustrated, to designate the content element, the user may right-click anywhere on the hierarchical representation (tree view) 500 to obtain a menu 510 that allows the user to select the action of highlighting the corresponding region on the browser (“Highlight on Web Browser”). The region may be highlighted in any number of colors or any other manner known to those having skill in the art. Responsive to the user designation of a content element on the hierarchical representation 500, a corresponding region 592 is highlighted on the displayed web page 501. In some embodiments of the present invention, the view of the web page in a browser window may be automatically modified such that the highlighted region of the web page may be visible to the user. It will be understood that the HTML representation module 124 (FIG. 1) may be configured to implement these aspects of some embodiments of the present invention.

In some embodiments of the present invention the browser may be configured to allow the modification of the view as discussed above. Browsers configured as such are discussed in U.S. Provisional Application Ser. No. ______ (Attorney Docket No. 5670-46) to Lebel, entitled Methods, Systems and Computer Program Products For Monitoring a Browsing Session, filed concurrently herewith, the disclosure of which is hereby incorporated herein by reference as if set forth in its entirety.

Similarly, a region may be designated on the web page to identify a corresponding content element in the hierarchical representation. For example, as illustrated in FIG. 5B, a region 594 may be designated on the web page 502. For example, to designate the region 594, the user may right-click anywhere on the web page 502 to obtain a menu 511 which allows the user to select the action of highlighting/locating the corresponding content element on the hierarchical representation (“Retrieve object on HTML Structure”). In some embodiments of the present invention, the view of the hierarchical representation of the web page may be automatically modified such that the highlighted content element may be visible to the user. It will be understood that the HTML representation module 124 (FIG. 1) may be configured to implement these aspects of some embodiments of the present invention.

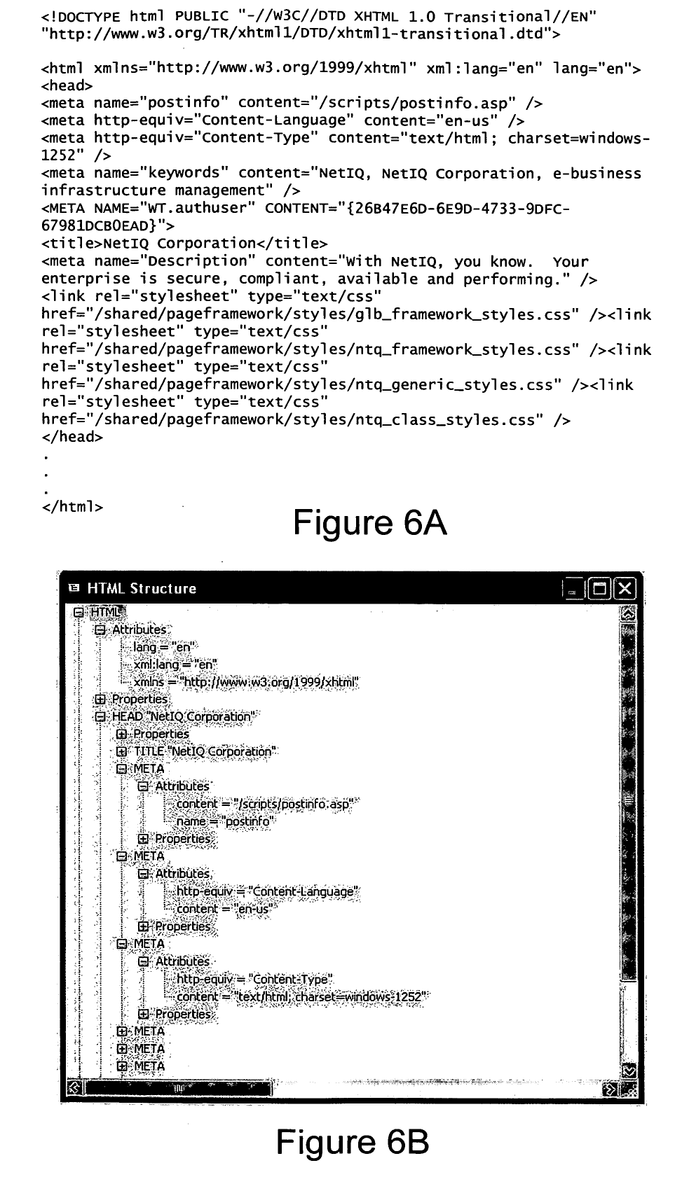

Referring now to FIGS. 6A and 6B, an exemplary generation of a hierarchical representation from HTML code according to some embodiments of the present invention is illustrated. FIG. 6A illustrates a fragment of the header of a typical HTML document. Methods according to some embodiments of the present invention are performed and a hierarchical representation of the HTML document is provided as shown in FIG. 6B.

It will be understood that some embodiments of the present invention may be used in combination with a Web Recorder product provided by NetIQ Corporation of San Jose, Calif. As discussed above with respect to FIGS. 1 through 6B, hierarchical representations according to some embodiments of the present invention may be useful for debugging a web page or an interaction problem between the Web Recorder product and, for example, a Web site. According to some embodiments of the present invention, a searchable, readable interface between the user and a web browser, for example, Internet Explorer is provided as discussed above with respect to FIGS. 2 through 6B. The hierarchical representation may provide a snapshot of a web page from the perspective of the web browser. Thus, the web page may be debugged using the hierarchical representation according to some embodiments of the present invention instead of the HTML code, which could be very difficult. Thus, some embodiments of the present invention may provide improved debugging methods as discussed herein.

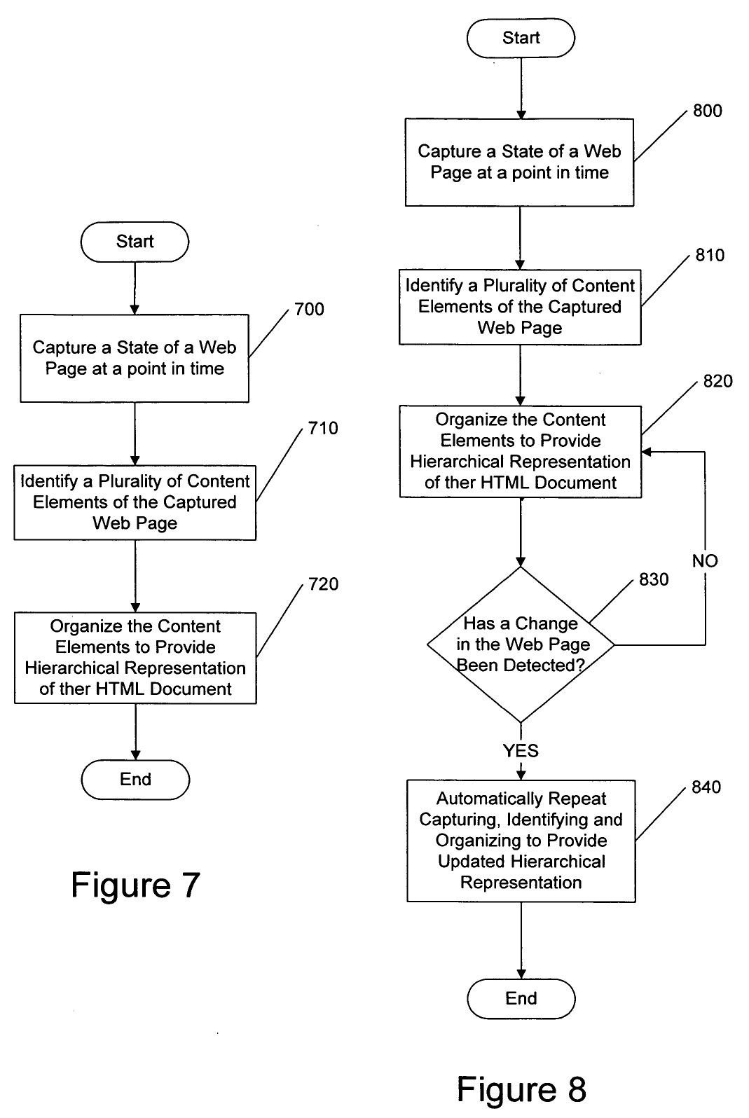

Operations according to various embodiments of the present invention will now be discussed with respect to the flowchart illustrations of FIGS. 7 through 10. Referring first to FIG. 7, operations for generating a hierarchical representation of a hypertext markup language (HTML) document according to some embodiments of the present invention will be discussed. Operations begin at block 700 by capturing a state of a web page at a point in time, i.e., a current state of a web page as displayed on a user terminal or display. A plurality of content elements of the captured web page are identified (block 710). The respective content elements have an associated type and/or content. The type can be an HTML defined standard or can be a type defined by the user. The content may include an attribute, a property and/or a child or children.

The content elements are organized to provide a grouping of the content elements based on the type and/or the content of the content elements to provide the hierarchical representation of the HTML document (block 720). The hierarchical representation may include the content elements and the associated types, attributes, properties and children as discussed above with respect to FIG. 2.

In some embodiments of the present invention, the content elements may be organized to provide a subset of the content elements based on the type and/or the content of the content elements in the hierarchical representation of the HTML document. For example, the subset of content elements may include only frame and/or form type content elements in the hierarchical representation of the HTML document. Embodiments of the present invention are not limited to this example, as the hierarchical representation may be limited to other types and/or content without departing from the scope of the present invention.

Referring now to FIG. 8, operations for generating a hierarchical representation of a hypertext markup language (HTML) document according to further embodiments of the present invention will be discussed. The operations of blocks 800 through 820 are similar to the operations discussed above with respect to blocks 700 through 720 of FIG. 7 and, therefore, the details with respect to these blocks will not be repeated herein.

For the embodiments of FIG. 8, after providing a hierarchical representation of the web page (block 820), it is determined if the web page has changed, for example, has the viewed portion of the web page in a browser window on the user's display changed (block 830). For example, has the user scrolled down the page. If a change is detected (block 830), operations of blocks 800 through 820 may be repeated to provide an updated hierarchical representation of the HTML document (block 840). If, on the other hand, a change is not detected (block 830), operations may remain at block 830 until a change is detected. It will be understood that, in some embodiments of the present invention, the repetition of blocks 800 through 820 may be initiated by a user and may not be performed automatically and a user request rather than a change may be detected (received) at block 830.

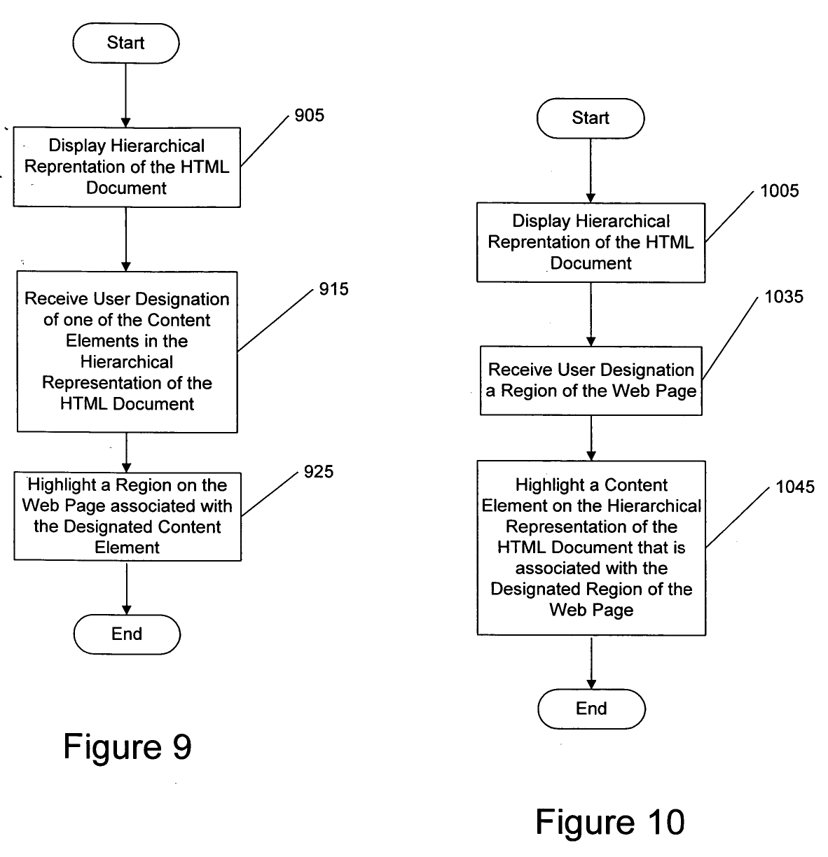

Operations according to still further embodiments of the present invention will be discussed with respect to FIG. 9. Operations begin at block 905 by displaying the hierarchical representation of the HTML document proximate a display of the web page on a user display. For example, as illustrated in FIG. 5A, the hierarchical representation 500 and the web page 501 are provided side by side on a user display. A user designation of one of the content elements in the displayed hierarchical representation of the HTML document is received (block 915). For example, a user may highlight the content element of interest, right click on the hierarchical representation and select a menu item indicating that a corresponding region of the web page should be highlighted. A region of the displayed web page associated with the designated one of the content elements is highlighted responsive to the received user designation of the one of the content elements (block 925). The region can be highlighted in any number of colors or any other manner known to those having skill in the art. Operations of block 945 may also include changing the view such that the highlighted region is visible.

Operations according to further embodiments of the present invention will now be discussed with respect to the flowchart of FIG. 10. Operations begin at block 1005 by displaying the hierarchical representation of the HTML document proximate a display of the web page on a user display. A user designation of a region of the displayed web page is received (block 1035). One of the content elements in the displayed hierarchical representation of the HTML document associated with the designated region of the displayed web page is highlighted responsive to the received user designation of the region (block 1045). Operations of block 1045 may further include changing the view such that the highlighted content element is visible to the user.

The flowcharts, screen shots, code blocks and block diagrams of FIGS. 1 through 10 illustrate the architecture, functionality, and operations of some embodiments of methods, systems, and computer program products for generating a hierarchical representation of a hypertext markup language (HTML) document. In this regard, each block represents a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method for generating a hierarchical representation of a hypertext markup language (HTML) document, the method comprising:
capturing a state of a web page at a point in time;
identifying a plurality of content elements of the captured web page;
organizing the content elements to provide a grouping of the content elements based on an associated type and/or content of respective ones of the content elements to provide the hierarchical representation of the HTML document.

2. The method of claim 1, wherein organizing the content elements further comprises organizing the content elements to provide a subset of the content elements based on the associated type and/or content of the content elements in the hierarchical representation of the HTML document.

3. The method of claim 2, wherein the subset includes only frame and/or form type content elements in the hierarchical representation of the HTML document.

4. The method of claim 1, further comprising:
detecting a change in the web page; and
automatically repeating capturing a state, identifying a plurality of content elements and organizing the content elements responsive to detecting the change in the web page to provide an updated hierarchical representation of the HTML document.

5. The method of claim 1, wherein identifying a plurality of content elements comprises identifying a plurality of content elements associated with a child window nested in the captured web page and wherein organizing the content elements comprises grouping the plurality of content elements associated with the child window in the hierarchical representation of the HTML document.

6. The method of claim 5, wherein the grouping of the plurality of content elements associated with the child window are nested in groupings of a parent window of the hierarchical representation of the HTML document.

7. The method of claim 1, wherein organizing the content elements comprises organizing the content elements to include an identification of attributes and/or of properties associated with ones of the content elements in the hierarchical representation of the HTML document, wherein the attributes and/or properties associated with ones of the content elements are grouped separately in the hierarchical representation of the HTML document.

8. The method of claim 1, wherein organizing the content elements comprises organizing the content elements to include an identification of parent/child relationships and screen coordinates associated with ones of the content elements in the hierarchical representation of the HTML document.

9. The method of claim 8, wherein the screen coordinates comprise view coordinates in a browser window.

10. The method of claim 1, further comprising:
displaying the hierarchical representation of the HTML document proximate a display of the web page on a user display;
receiving a user designation of one of the content elements in the displayed hierarchical representation of the HTML document; and
highlighting a region of the displayed web page associated with the designated one of the content elements responsive to the received user designation of the one of the content elements.

11. The method of claim 10, further comprising automatically modifying a view of the web page in a browser window so the highlighted region is visible.

12. The method of claim 1, further comprising:
displaying the hierarchical representation of the HTML document proximate a display of the web page on a user display;
receiving a user designation of a region of the displayed web page; and
highlighting one of the content elements in the displayed hierarchical representation of the HTML document associated with the designated region of the displayed web page responsive to the received user designation of the region.

13. The method of claim 12, further comprising automatically modifying a view of the hierarchical representation of the HTML document in a display window so that the highlighted content element is visible.

14. A system for generating a hierarchical representation of a hypertext markup language (HTML) document, the system comprising:
a representation module configured to capture a state of a web page at a point in time, identify a plurality of content elements of the captured web page and organize the content elements to provide a grouping of the content elements based on an associated type and/or content of respective ones of the content elements to provide the hierarchical representation of the HTML document.

15. The system of claim 14, wherein the representation module is further configured to organize the content elements to provide a subset of the content elements based on the associated type and/or content of the content elements in the hierarchical representation of the HTML document.

16. The system of claim 15, wherein the subset includes only frame and/or form type content elements in the hierarchical representation of the HTML document.

17. The system of claim 14, wherein the representation module is further configured to:
detect a change in the web page; and
automatically repeat capturing a state, identifying a plurality of content elements and organizing the content elements responsive to detecting the change in the web page to provide an updated hierarchical representation of the HTML document.

18. The system of claim 14, wherein the representation module is further configured to:
identify a plurality of content elements associated with a child window nested in the captured web page; and
group the plurality of content elements associated with the child window in the hierarchical representation of the HTML document.

19. The system of claim 14, wherein the representation module is further configured to organize the content elements to include an identification of attributes and/or of properties associated with ones of the content elements in the hierarchical representation of the HTML document, wherein the attributes and/or properties associated with ones of the content elements are grouped separately in the hierarchical representation of the HTML document.

20. The system of claim 14, wherein the representation module is further configured to organize the content elements to include an identification of parent/child relationships and screen coordinates associated with ones of the content elements in the hierarchical representation of the HTML document.

21. The system of claim 14, further comprising a user display configured to communicate with the representation module, wherein the representation module is further configured to:
display the hierarchical representation of the HTML document proximate a display of the web page on the user display;
receive a user designation of one of the content elements in the displayed hierarchical representation of the HTML document; and
highlight a region of the displayed web page associated with the designated one of the content elements on the user display responsive to the received user designation of the one of the content elements.

22. The system of claim 14, further comprising a user display configured to communicate with the representation module, wherein the representation module is further configured to:
display the hierarchical representation of the HTML document proximate a display of the web page on the user display;
receive a user designation of a region of the displayed web page; and
highlight one of the content elements in the displayed hierarchical representation of the HTML document associated with the designated region of the displayed web page on the user display responsive to the received user designation of the region.

23. A computer program product for generating a hierarchical representation of a hypertext markup language (HTML) document, the computer program product comprising:
a computer readable medium having computer readable program code embodied therein, the computer readable program code comprising:
computer readable program code configured to capture a state of a web page at a point in time;
computer readable program code configured to identify a plurality of content elements of the captured web page;
computer readable program code configured to organize the content elements to provide a grouping of the content elements based on an associated type and/or content of respective ones of the content elements to provide the hierarchical representation of the HTML document.

24. The computer program product of claim 23, wherein the computer readable program code configured to organize the content elements further comprises computer readable program code configured to organize the content elements to provide a subset of the content elements based on the associated type and/or content of the content elements in the hierarchical representation of the HTML document.

25. The computer program product of claim 24, wherein the subset includes only frame and/or form type content elements in the hierarchical representation of the HTML document.

26. The computer program product of claim 23, further comprising:
computer readable program code configured to detect a change in the web page; and
computer readable program code configured to automatically repeat capturing a state, identifying a plurality of content elements and organizing the content elements responsive to detecting the change in the web page to provide an updated hierarchical representation of the HTML document.

27. The computer program product of claim 23, wherein the computer readable program code configured to identify a plurality of content elements comprises computer readable program code configured to identify a plurality of content elements associated with a child window nested in the captured web page and wherein organizing the content elements comprises grouping the plurality of content elements associated with the child window in the hierarchical representation of the HTML document.

28. The computer program product of claim 23, wherein the computer program product configured to organizes the content elements comprises computer readable program code configured to organize the content elements to include an identification of attributes and/or of properties associated with ones of the content elements in the hierarchical representation of the HTML document, wherein the attributes and/or properties associated with ones of the content elements are grouped separately in the hierarchical representation of the HTML document.

29. The computer program product of claim 23, wherein the computer readable program code configured to organize the content elements comprises computer readable program code configured to organize the content elements to include an identification of parent/child relationships and screen coordinates associated with ones of the content elements in the hierarchical representation of the HTML document.

30. The computer program product of claim 23, further comprising:
computer readable program code configured to display the hierarchical representation of the HTML document proximate a display of the web page on a user display;
computer readable program code configured to receive a user designation of one of the content elements in the displayed hierarchical representation of the HTML document; and
computer readable program code configured to highlight a region of the displayed web page associated with the designated one of the content elements responsive to the received user designation of the one of the content elements.

31. The computer program product of claim 23, further comprising:
computer readable program code configured to display the hierarchical representation of the HTML document proximate a display of the web page on a user display;
computer readable program code configured to receive a user designation of a region of the displayed web page; and
computer readable program code configured to highlight one of the content elements in the displayed hierarchical representation of the HTML document associated with the designated region of the displayed web page responsive to the received user designation of the region.
